(19) United States
(12) Patent Application Publication
(10) Pub. No.: US 2026/0328728 A1
(43) Pub. Date: Oct. 22, 2026

(54) NONDESTRUCTIVE INSPECTING DEVICE, NONDESTRUCTIVE INSPECTING METHOD, AND PROGRAM

(71) Applicant: KONICA MINOLTA, INC., Chiyoda-ku, Tokyo (JP)

(72) Inventors: Masaru FUSE, Oosaka (JP); Megumi AOKI, Hyogo (JP)

(73) Assignee: KONICA MINOLTA, INC., Chiyoda-ku, Tokyo (JP)

(21) Appl. No.: 18/997,955

(22) PCT Filed: Jun. 13, 2023
(86) PCT No.: PCT/JP2023/021968

§ 371 Date: Jan. 23, 2025

(30) Foreign Application Priority Data
Jul. 28, 2022 (JP) 2022-120656

(51) Int. Cl. G01N 29/04; G01N 29/11; G01N 29/44

(52) U.S. Cl. CPC G01N 29/043; G01N 29/11; G01N 29/4445; G01N 2291/012; G01N 2291/0231

(57) ABSTRACT

Provided are a nondestructive inspecting device, a nondestructive inspecting method, and a program capable of detecting even minute defects at low cost. The nondestructive inspecting device of the present invention comprises: a transmitting unit for transmitting wave motion to a target object; a receiving unit for generating a reception signal by receiving the wave motion propagated through the target object, at a plurality of reception positions on a line or a plane orthogonal to a transmission direction of the wave motion; and an information generating unit for subjecting the reception signal and a predetermined reference signal to predetermined non-linear processing to generate phase shift information indicating a phase shift between the reception signal and the reference signal at each reception position.

### TECHNICAL FIELD

The present invention relates to a nondestructive inspecting device, a nondestructive inspecting method, and a program.

### BACKGROUND ART

In recent years, against the background of environmental problems, energy problems, and the like, composite fiber reinforced plastic materials such as CFRP (Carbon Fiber Reinforced Plastic) are increasingly being used as the bodies of moving vehicles such as aircraft and automobiles, as well as structural materials for relatively large facilities and buildings such as bridges and roads. Such a composite material has excellent characteristics such as a light weight and a high strength as compared with a metal or the like, but it is pointed out that when there is a fine void (gap), internal peeling, or the like at the time of production or the like, there is a possibility that the composite material is largely broken or fractured due to aging deterioration. In addition, concrete, which is often used for a large-scale building, has high toughness at the beginning of production or construction, but voids in the concrete, corrosion of internal reinforcing bars, and the like may occur due to changes in properties over time, penetration of moisture, and the like, and the strength may greatly deteriorate. Therefore, in order to efficiently evaluate and ensure the safety and reliability of such mobile bodies, infrastructures, buildings, and the like, nondestructive inspection is performed.

Further, in recent years, due to the improvement of consumer minds regarding product safety, the movement of strengthening regulations accompanying this, and the like, the social trend of requiring high safety for consumer goods in general including food products has been intensified, and a nondestructive inspecting method of simply evaluating these qualities has been required.

Conventionally, for such nondestructive inspection, analog methods based on know-how of craftsman and human-wave tactics, such as tapping sound inspection and appearance inspection, have often been used. However, it is difficult to maintain or inherit the technology of the analog method, and there are many problems in terms of efficiency. Therefore, there is a need for a nondestructive inspecting method that is more quantitative, has high work efficiency, and can be performed in a short time.

Therefore, as such an efficient and quantitative nondestructive inspecting method, a nondestructive inspecting method using waves such as electromagnetic waves or ultrasonic waves has been proposed and put into practical use. As a representative method of such a nondestructive inspecting method, an ultrasonic flaw detection method or the like is known. In the ultrasonic flaw detection method, an ultrasonic sensor is brought into contact with an object, an ultrasonic wave is made incident on the object, and the ultrasonic wave reflected from the object or the ultrasonic wave transmitted through the object is observed to grasp the structure in the object and the presence of absence of a defect such as a void or a crack.

An example of the most general configuration as the ultrasonic flaw detection method is illustrated in FIG. 13A. FIG. 13A illustrates a configuration in which two sensors for transmitting and receiving ultrasonic waves are disposed with respect to an object, ultrasonic waves are transmitted from one sensor to the object, and the ultrasonic waves reflected by the object are received by the other sensor. In this configuration, the presence or absence of a void or the like and the size of the void or the like are detected by measuring reflected energy of an ultrasonic wave caused by discontinuity of acoustic impedance due to a defect such as a void in an object.

In addition, Japanese Unexamined Patent Publication No. 2019-20250 discloses a nondestructive inspecting device that transmits two ultrasonic waves having different frequencies to an object and determines the presence or absence of a defect on the basis of a beat waveform (beat) in a reception signal due to phase fluctuation generated when the two ultrasonic waves are transmitted through or reflected by an internal defect or the like, instead of the method of detecting ultrasonic energy as described above.

### SUMMARY OF INVENTION

### Technical Problem

However, in the method illustrated in FIG. 13, the detection performance depends on the size of the defect or the like due to the basic principle that the energy amount of the ultrasonic wave reflected by the interface of the internal defect or the like is detected. Therefore, as illustrated in FIG. 13B of the drawing, although a large defect can be accurately detected, it may be difficult to detect a small defect such as a minute crack that is observed at an extremely early stage or the like of a deterioration process of the object.

The nondestructive inspecting device disclosed in Japanese Unexamined Patent Publication No. 2019-20250 can be expected to detect a smaller defect or the like than the method illustrated in FIG. 13 by observing the phase fluctuation of the ultrasonic wave. However, it is necessary to provide two transmitters in order to transmit ultrasonic waves having frequencies different from each other, and there is a high possibility that the cost of the nondestructive inspecting device increases.

Further, in these known techniques, it is necessary to acquire ultrasonic data to be analyzed for detecting a defect or the like by actual measurement by actually propagating an ultrasonic wave through an object. Therefore, there is also a problem that a cost is high in terms of time and equipment with respect to the entire inspection work. For example, as in the nondestructive inspecting device disclosed in Japanese Unexamined Patent Publication No. 2019-20250, in order to detect the phase fluctuation of the wave propagating through the object, some kind of reference signal is required. However, in order to acquire data of such a reference signal, it is extremely difficult or costly to actually prepare another object that has the same internal parameters as the inspection object and in which it is known in advance that no defect exists.

Therefore, an object of the present invention is to provide a nondestructive inspecting device, a nondestructive inspecting method, and a program capable of detecting a phase fluctuation of an ultrasonic wave easily and at low cost from time-series signal data obtained by propagating the ultrasonic wave through an object

### Solution to Problem

In order to solve the above-described problem, a nondestructive inspecting device according to an aspect of the present invention includes: a transmitter that transmits waves to an object; a receiver that receives, at a plurality of reception positions on a line or a plane substantially orthogonal to a transmission direction of the waves, the waves propagated via the object and generates a reception signal; and an information generator that performs a predetermined nonlinear process on the reception signal and a predetermined reference signal, and generates phase shift information indicating a phase shift between the reception signal and the reference signal at each of the reception positions.

A nondestructive inspecting method according to an aspect of the present invention is a method that is executed by a computer, the method comprising: transmitting waves to an object; receiving, at a plurality of reception positions on a line or a plane substantially orthogonal to a transmission direction of the waves, the waves propagated via the object and generates a reception signal; and performing a predetermined nonlinear process on the reception signal and a predetermined reference signal, and generates phase shift information indicating a phase shift between the reception signal and the reference signal at each of the reception positions.

A program according to an aspect of the present invention is configured to be executed by a computer included in a nondestructive inspecting device, the program causing a computer to execute: transmitting waves to an object; receiving, at a plurality of reception positions on a line or a plane substantially orthogonal to a transmission direction of the waves, the waves propagated via the object and generates a reception signal; and performing a predetermined nonlinear process on the reception signal and a predetermined reference signal, and generates phase shift information indicating a phase shift between the reception signal and the reference signal at each of the reception positions.

### Advantageous Effects of Invention

According to the present invention, phase fluctuation of an ultrasonic wave can be detected simply and at low cost from time-series signal data obtained by propagating the ultrasonic wave through an object.

### BRIEF DESCRIPTION OF THE DRAWINGS

FIG. 1 is a diagram illustrating an example of the configuration of the nondestructive inspecting device according to the first embodiment of the present invention;

FIG. 2 is a diagram illustrating a positional relationship between a transmitter, a receiver, and an object in the nondestructive inspecting device according to the first embodiment of the present invention;

FIG. 3A is a diagram illustrating waves received at each reception position in a case where a structure such as a defect that reflects or scatters waves does not exist inside the object;

FIG. 3B is a diagram illustrating waves received at each reception position in a case where a structure such as a defect that reflects waves or the like exists inside an object;

FIG. 4 is a diagram conceptually illustrating the principle by which a phase shift detector generates phase shift information according to the first embodiment of the present invention;

FIG. 5A is a diagram illustrating a relationship between phase shift information obtained by propagating ultrasonic waves through an object having a void therein and a reception position, using the nondestructive inspecting device according to the first embodiment of the present invention;

FIG. 5B is a diagram illustrating a relationship between phase shift information obtained by propagating ultrasonic waves through an object having a void therein and a reception position, using the nondestructive inspecting device according to the first embodiment of the present invention;

FIG. 5C is a diagram illustrating a relationship between phase shift information obtained by propagating ultrasonic waves through an object having a void therein and a reception position, using the nondestructive inspecting device according to the first embodiment of the present invention;

FIG. 5D is a diagram illustrating a relationship between phase shift information obtained by propagating ultrasonic waves through an object having a void therein and a reception position, using the nondestructive inspecting device according to the first embodiment of the present invention;

FIG. 6A is a diagram illustrating a relationship between phase shift information and a reception position obtained by propagating ultrasonic waves through an object having no defect therein using the nondestructive inspecting device according to the first embodiment of the present invention;

FIG. 6B is a diagram illustrating a relationship between phase shift information obtained by propagating ultrasonic waves through an object having no defect therein and a reception position by using the nondestructive inspecting device according to the first embodiment of the present invention;

FIG. 6C is a diagram illustrating a relationship between phase shift information obtained by propagating ultrasonic waves through an object having no defect therein and a reception position by using the nondestructive inspecting device according to the first embodiment of the present invention;

FIG. 6D is a diagram illustrating a relationship between phase shift information and a reception position obtained by propagating ultrasonic waves through an object having no defect therein using the nondestructive inspecting device according to the first embodiment of the present invention;

FIG. 7 is a diagram illustrating an example of the configuration of the nondestructive inspecting device according to the second embodiment of the present invention;

FIG. 8 is a diagram illustrating phase shift detection processing in the nondestructive inspecting device according to the second embodiment of the present invention;

FIG. 9A is a diagram illustrating a relationship between phase shift information obtained by propagating ultrasonic waves through an object having a void therein and a reception position using the nondestructive inspecting device according to the second embodiment of the present invention;

FIG. 9B is a diagram illustrating a relationship between phase shift information obtained by propagating ultrasonic waves through an object having a void therein and a reception position using the nondestructive inspecting device according to the second embodiment of the present invention;

FIG. 9C is a diagram illustrating a relationship between phase shift information obtained by propagating ultrasonic waves through an object having a void therein and a reception position using the nondestructive inspecting device according to the second embodiment of the present invention;

FIG. 9D is a diagram illustrating the relation between phase shift information obtained by propagating ultrasonic waves through an object having voids therein and a reception position, using the nondestructive inspecting device according to the second embodiment of the present invention;

FIG. 10 is a diagram illustrating an example of the configuration of the nondestructive inspecting device according to the third embodiment of the present invention;

FIG. 11 is a diagram illustrating an example of the configuration of the nondestructive inspecting device according to the fourth embodiment of the present invention;

FIG. 12 is a diagram illustrating an example of the configuration of the nondestructive inspecting device according to the fifth embodiment of the present invention;

FIG. 13A is a diagram illustrating an example of a configuration of a known nondestructive inspecting device; and

FIG. 13B is a diagram illustrating the principle of a known nondestructive inspecting device.

### DESCRIPTION OF EMBODIMENTS

Hereinafter, embodiments of the present invention will be described with reference to the drawings. However, the scope of the invention is not limited to the illustrated examples, and includes forms and configurations equivalent thereto. Note that in the following description, components having the same function and configuration are denoted by the same symbol, and descriptions thereof are omitted

### First Embodiment

### Overall Configuration of Nondestructive Inspecting device 100

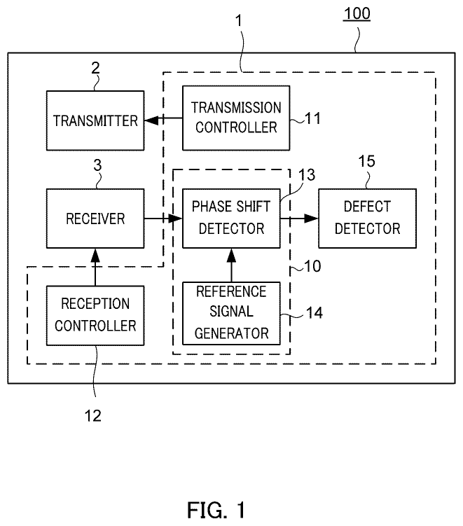

FIG. 1 is a diagram illustrating an example of a configuration of a nondestructive inspecting device 100 according to the first embodiment. As illustrated in FIG. 1, the nondestructive inspecting device 100 includes a controller 1, a transmitter 2, and a receiver 3, and is a kind of computer device having a computer therein. With this configuration, the nondestructive inspecting device 100 nondestructively inspects the presence or absence of a defect of the object. Representative examples of the object to be nondestructively inspected include solid objects such as composite fiber resin such as CFRP and reinforced concrete, but the object is not limited thereto, and liquid and gas are also assumed. In addition, hereinafter, a case where the object is a hexahedron will be described, but the shape of the object is not limited thereto, and may be, for example, a sphere, an ellipsoid, a cylinder, an elliptic cylinder, a prism, an indefinite shape, or the like.

The controller 1 is formed with, for example, a processor such as a Central Processing Unit (CPU) or a microprocessor, or an arithmetic circuit such as an application-specific integrated circuit (ASIC) or a field-programmable gate array (FPGA), and includes a plurality of functional blocks. Using the plurality of functional blocks, the controller 1 provides the transmitter 2 with control information on transmission conditions such as transmission timing and transmission waveform of waves, provides the receiver 3 with control information, and performs predetermined signal processing and the like on a reception signal of waves output from the receiver 3, and outputs or displays an inspection result.

The transmitter 2 transmits a predetermined wave to an object on the basis of control information provided from the controller 1. Examples of the waves transmitted by the transmitter 2 include acoustic waves such as ultrasonic waves and electromagnetic waves such as radio waves and light waves, but hereinafter, the transmitter 2 transmits ultrasonic waves. Although a plane wave, a spherical wave, and the like are assumed as wavefront shape of waves transmitted by the transmitter 2, hereinafter, it is assumed that the wave is a plane wave, that is, waves having wavefront in a direction perpendicular to a propagation direction. Further, the wave generation element that forms the transmitter 2 may have either a single-element configuration or a multiple-element configuration as long as a desired wavefront shape can be obtained.

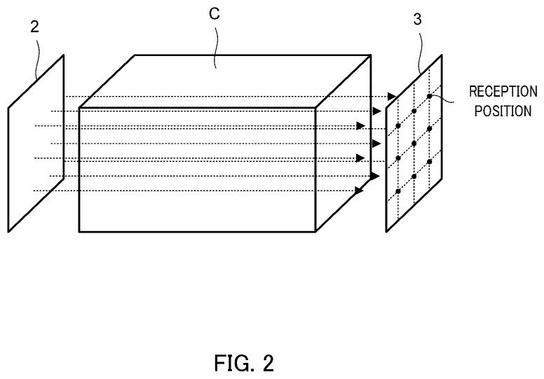

For example, the receiver 3 is disposed to face the transmitter 2 with the object interposed therebetween, and receives the wave transmitted from the transmitter 2 and propagated through the object C on the basis of the control information provided from the controller 1. FIG. 2 is a diagram illustrating a positional relationship between the transmitter 2, the receiver 3, and the object C, in which the transmitter 2 is disposed on one of two surfaces of the object C facing each other, and the receiver 3 is disposed on the other surface.

The receiver 3 includes a plurality of reception elements and is configured to be able to receive the wave propagating through the object C at a plurality of reception positions (black circles in FIG. 2) in a space. The plurality of reception positions is arranged on a plane or a straight line substantially orthogonal to the transmission direction of the waves, and each reception element of the receiver 3 receives the waves having propagated through the object C at each of the plurality of reception positions. Accordingly, the receiver 3 can receive the plane waves transmitted by the transmitter 2 and having the wavefronts perpendicular to the propagation direction substantially simultaneously by the reception elements arranged at the plurality of reception positions, convert the plane waves into electric signals, and output the electric signals.

In the present specification, the description “substantially orthogonal” includes not only a state where the transmission direction and the plane or the straight line are truly orthogonal to each other, but also a state where the transmission direction and the plane or the straight line are slightly deviated from the truly orthogonal state, which may occur due to, for example, an installation tolerance of the transmitter 2 and the receiver 3.

Note that, although this figure illustrates a so-called transmission-type transmission and reception configuration in which the transmitter 2 and the receiver 3 are arranged on mutually different sides with respect to the object C, a so-called reflection-type configuration in which the transmitter 2 and the receiver 3 are arranged on the same side is also possible.

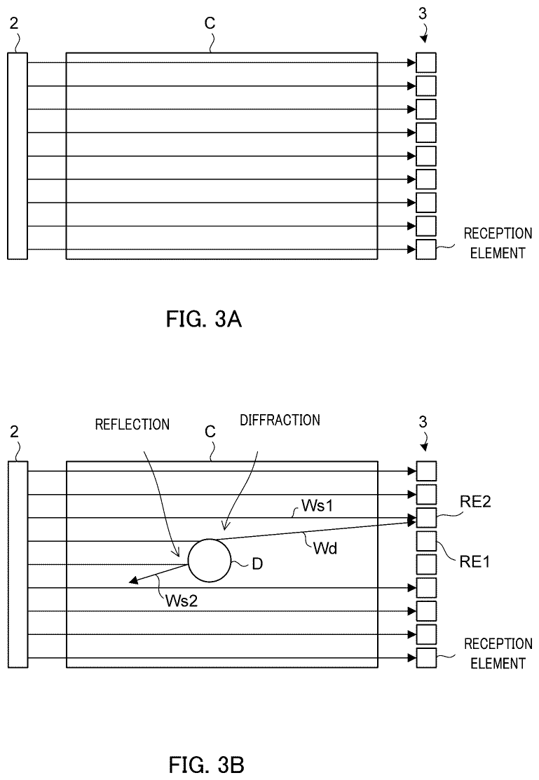

Here, referring to FIG. 3, the waves propagated by the object C will be described. FIGS. 3A and 3B illustrate the transmitter 2, the receiver 3, and the object C in a side view. FIG. 3A illustrates waves received at each reception position in a case where no structure, such as a defect, that reflects or scatters waves exists inside the object C. In FIG. 3A, for example, similarly to the receiver 3, the transmitter 2 has a configuration formed with a plurality of transmission elements and aligns timings of transmission signals to be input to the respective transmission elements, thereby aligning wavefronts of waves output from the respective transmission elements to generate a plane wave. In FIG. 3A, since no factor that delays wave propagation, such as reflection or scattering of waves, exists inside the object C, the waves output from the transmitter 2 reach the respective reception elements of the receiver 3 at the same timing without being processed. That is, the plurality of reception elements of the receiver 3 can be regarded as simultaneously receiving a plurality of straight waves (arrows in FIG. 3A) that are simultaneously transmitted from the transmitter 2 and travel in parallel.

On the other hand, FIG. 3B illustrates an example of waves received at each reception position in a case where a structure such as a defect that reflects waves or the like exists inside the object C. In FIG. 3B, similarly to FIG. 3A, waves output from the transmitter 2 travel straight through the object C. However, the straight wave propagating in the vicinity of the defect D is reflected by the boundary surface of the defect D, and reaches, for example, the second reception element REI arranged adjacent to the first reception element RE2 instead of the first reception element SL that is supposed to reach, and the reflected wave Wd is received. Thus, in the example illustrated in FIG. 3B, the second reception elements RE2 receive both the straight waves Ws1 and the reflected waves Wd.

Note that FIG. 3B illustrates a state in which the waves are reflected at the upper side part of the interface of the defect D, but a similar phenomenon can occur at the lower side part of the interface of the defect D. Further, the angle at which the wave is reflected may vary depending on conditions such as the incident angle and incident position of the wave on the defect interface and the shape of the defect. For example, FIG. 3B illustrates a state in which the wave is reflected outward (upward in FIG. 3B) from the center of the defect D, but the wave may be diffracted inward from the center of the defect depending on conditions, and thus the reception element that the wave reaches may be changed. Note that most of the waves Ws2 that have reached the front of the defect are reflected by the defect in the direction opposite to the propagation direction, and therefore none of the waves are received by the reception elements positioned on the back side of the defect in the propagation direction of the waves (the right side in the drawing 3B).

As described above, the waves that the receiver 3 receives by each reception element change while reflecting the internal structure or the like of the object. Therefore, by processing and analyzing each reception signal outputted from the plurality of reception elements of the receiver 3 by a predetermined method, it is possible to detect the presence or absence of a defect or the like inside the object.

### Controller 1

Referring back to FIG. 1, operations of the functional blocks included in the controller 1 will be described. As illustrated in FIG. 1, the controller 1 includes an information generator 10, a transmission controller 11, a reception controller 12, and a defect detector 15. The information generator 10 further includes a phase shift detector 13 and a reference signal generator 14.

The transmission controller 11 controls the transmitter 2 so as to transmit the waves to the object C under predetermined transmission conditions such as waveform, a frequency, and transmission timing.

The reception controller 12 controls the receiver 3 so that the reception element arranged at the predetermined reception position receives the wave that has been transmitted by the transmitter 2 and propagated through the object C.

The reference signal generator 14 generates, by a predetermined method and configuration, a reference signal that is waves whose waveform, frequency, and the like match those of a transmission signal output from the transmitter 2. As illustrated in FIG. 3A, the reference signal is a signal, a or a similar signal that is equivalent to a signal outputted from each of the reception elements under conditions where no structure that diffracts waves or the like, such as a defect, exists inside the object and each of the plurality of reception elements receives only straight waves. In the present invention, various methods can be adopted as a method of generating the reference signal. A method of generating the reference signal will be described later.

The phase shift detector 13 generates, based on the reference signal, phase shift information indicating a change in the phase of the reception signal output from the receiver 3 by a predetermined method. In a case where a significant value is detected as the phase shift information, a structure that diffracts or the like the waves, such as a defect, exists inside the object.

### Method of Generating Phase Shift Information

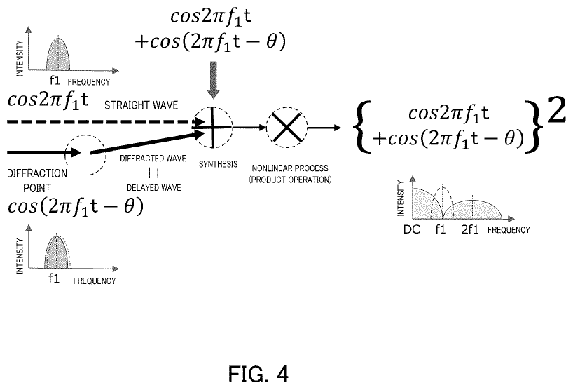

A method of generating the phase shift information will be described. FIG. 4 is a diagram conceptually illustrating processing content for the phase shift detector 13 to generate phase shift information for a reception signal output by a reception element at a certain reception position. As described above, the reception signal includes, for each reception element, one or both of components of a straight wave corresponding to the reception position and a diffracted wave due to a defect or the like, depending on the position and size of the defect or the like inside the object.

FIG. 4 illustrates the case where the reception signal includes only the diffracted wave component. The reference signal corresponds to a reception signal that is output when the reception element receives only a straight wave component. The phase shift detector 13 combines the reception signal, which is a diffracted wave, and a reference signal, which corresponds to a straight wave, performs nonlinear processing to calculate an interference component between the two signals, and generates phase shift information on the basis of the magnitude of the interference component.

Here, assuming that the frequencies of the waves transmitted from the transmitter 2 are f₁, for example, a straight wave can be expressed as cos 2πf₁t. t is time. On the other hand, since the diffracted wave is diffracted at the interface of the defect and reaches the reception element as illustrated in FIG. 3B, the propagation time varies as compared with the straight wave, and the phase changes with the straight wave as a reference. That is, the diffracted wave can be expressed as cos(2πf₁t−θ), where θ is the phase shift (difference in phase) between the diffracted wave and the straight wave.

An output value in a case where the reception signal (diffracted wave) and the reference signal (straight wave) are combined (added) and a product operation is performed as an example of nonlinear process is expressed by the following Expression 1.

[1]

cos²2πf₁t+cos²(2πf₁t−θ)+2 cos 2πf₁t·cos(2πf₁t−θ) (1)

In Equation (1), 2 cos 2πf₁t·cos(2 πf₁t−θ) of the third term is an interfering element between the received signal and the reference signal. According to the sum-of-products formula, the third term is expressed by the following Equation 2.

[2]

{cos(2π2f₁t−θ)+cos θ} (2)

The graph on the right side of FIG. 4 schematically illustrates a frequency spectrum obtained when the reception signal and the reference signal interfere with each other. As illustrated therein, second harmonic components (center frequencies 2f₁) and DC components are obtained due to interference between the received signal and the reference signal. In Equation (2), the first half term corresponds to the second harmonic component, and the second half term corresponds to the DC component.

The magnitude of the DC component (cos θ) calculated by such processing is output to the defect detector 15 as phase shift information of the diffracted wave component.

Although the case where the reception signal has only the diffracted wave component has been described above, substantially the same operation and effect are exhibited also in the case where the reception signal has the diffracted wave component and the straight wave component. That is, the straight wave component included in the reception signal and the reference signal have the same waveform and frequency, and have a time difference corresponding to the time required for the straight wave component to propagate through the object C. In this case, when the reference signal having a sufficiently large amplitude is combined with the reception signal, the interference component between the diffracted wave component in the reception signal and the reference signal can be generated by the nonlinear processing because the straight wave component included in the reception signal can be ignored.

The reference signal generator 14 generates a reference signal by a predetermined method. Hereinafter, a method of generating the reference signal will be described.

### Method of Generating Reference Signal

The reference signal generator 14 generates the reference signal, for example, by performing simulation using a calculation model of the object.

The calculation model of the object is a model in which a virtual object that has internal parameters substantially matching those of the object C that is an inspection target of the nondestructive inspecting device 100 and does not have a defect or the like inside is created in an arithmetic space. In the present specification, the description “substantially match” includes a case where a slight difference in value caused by an error or the like is included between the internal parameter of the calculation model and the internal parameter of the object C. More specifically, the calculation model is generated on the basis of a known parameter group such as a physical property parameter and a structure parameter required when the object C is designed and produced. Note that the calculation model is not necessarily created by the nondestructive inspecting device 100, and may be created by an external computer or the like provided separately.

Next, an example of a method of generating a reference signal using a calculation model will be described. In an arithmetic space, waves having the same wave parameters (amplitude, phase, frequency, and the like) as a transmission signal output from the transmitter 2 are input to a calculation model, and a reception signal observed at the same positions as reception positions at which a plurality of reception elements included in the receiver 3 are respectively disposed is acquired by simulation and is used as a reference signal. Note that the simulation does not necessarily have to be performed by the nondestructive inspecting device 100 and may be performed by a separately provided external computer or the like.

As described above, the reference signal is generated by constructing the object of the nondestructive inspection as the calculation model in the arithmetic space and simulating the wave propagation in accordance with the actual transmission signal. Thus, the reference signal can be acquired more easily and at lower cost than in a case where an object without a defect or the like is actually prepared, waves are propagated using the transmitter 2 and the receiver 3, and the reception signal is used as the reference signal. This is because it is very difficult and costly to actually prepare another object that has the same physical parameters and structural parameters as those of the object to be nondestructively inspected and is known in advance to have no defect or the like.

Further, according to the generation method as described above, it is possible to generate the reference signal at a timing different from the timing at which the nondestructive inspecting device 100 performs the nondestructive inspection of the object C. That is, the reference signal generator 14 may generate the reference signal at the same timing as the timing at which the nondestructive inspecting device 100 actually inspects the object C in the real space, or may generate the reference signal at a timing different from the timing at which the actual inspection is performed. For example, by generating a reference signal in advance of actual nondestructive inspection and storing the data in a storage or the like of the reference signal generator 14, it is possible to reduce the workload of the nondestructive inspecting device 100 during actual inspection and perform efficient inspection. Alternatively, the reference signal may be generated after the actual inspection.

Note that in the example illustrated in FIG. 3, the object C to be nondestructively inspected is assumed to be formed of a homogeneous material, but is not necessarily limited thereto, and may be formed of a heterogeneous material or may have a heterogeneous structure. For example, the nondestructive inspecting device 100 of the present invention is also applicable to resin-based materials containing fibers, such as CFRTP (Carbon Fiber Reinforced Thermo Plastics), which is a type of composite fiber resins, and to materials having a laminated structure, such as CFRP.

When waves are input to an inhomogeneous object such as a CFRTP, the waves may be scattered or diffracted due to contained fibers or the like even if there is no defect or the like inside. In such a case, by constructing a calculation model using a material in which scattering or the like occurs, sufficient inspection accuracy can be obtained even in a case of an object formed of a heterogeneous material. In addition, in a case where CFRP is assumed as the object, it is possible to secure sufficient accuracy by constructing a calculation model on the basis of a known parameter group when the object is designed, such as the thickness of each ply layer or the adhesive layer, the content of the carbon fiber of the ply layer, and the physical properties of the resin material used for the adhesive layer.

Returning to FIG. 1, the defect detector 15 will be described. The defect detector 15 detects the presence of absence of a defect or the like and the size and position of the defect or the like inside the object C based on the phase shift information output from the phase shift detector 13.

The defect detector 15 determines that a defect or the like exists in the object C when there is a reception position at which significant phase shift information is detected among the reception positions at which the plurality of reception elements of the receiver 3 are arranged or when there is a reception position at which peculiar phase shift information is obtained as compared with the other reception positions. The defect detector 15 determines that a defect or the like is present on or near a line connecting the transmitter 2 and a reception position at which significant or unique phase shift information is obtained.

### Effects

According to the nondestructive inspecting device 100 related to the first embodiment, the following special effects are obtained.

The nondestructive inspecting device 100 propagates waves to an object, acquires reception signals by reception elements arranged at a plurality of reception positions, performs nonlinear processing on the reception signals with respect to a reference signal created or acquired in advance, and generates phase shift information on the reception signals, and thus can easily detect a defect or the like inside the object at low cost even if the defect or the like is minute.

Further, by generating the reference signal at a timing different from inspection using an actual object, and typically generating it in advance, it is possible to reduce the workload, the amount of calculation, and the like of the nondestructive inspecting device 100 at the time of actual inspection. Further, since the generation of the reference signal can be implemented by simulation in which waves having parameters (frequency and the like) equivalent to those of the wave transmitted by the transmitter 2 are incident on a calculation model having internal parameters equivalent to those of the object, it is possible to reduce the generation cost of the reference signal and the calculation cost of the phase shift detection processing based on the reference signal and the reception signal, thereby suppressing the inspection cost of the nondestructive inspecting device 100.

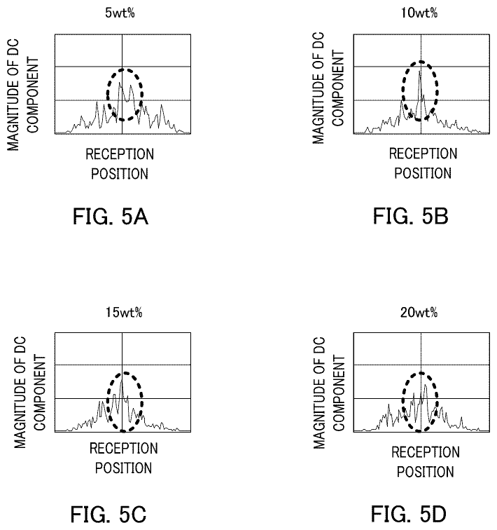

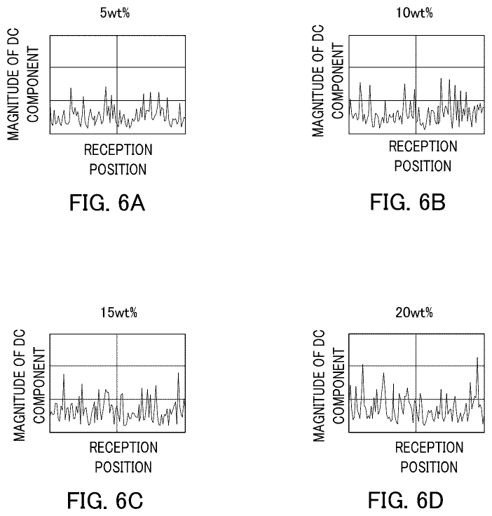

Next, data obtained when nondestructive inspection is performed using the nondestructive inspecting device 100 will be described with reference to FIG. 5 and FIG. 6.

FIGS. 5 and 6 illustrate a relationship between the magnitude of the DC component included in the phase shift information output from the phase shift detector 13 and the reception position with the content of the carbon fibers in the CFRTP as a parameter in a case where there is a gap having a diameter of 500 μm inside the object (FIG. 5) and in a case where there is no gap (FIG. 6), respectively. In each of FIGS. 5 and 6, the horizontal axis represents the reception position and the vertical axis represents the magnitude of the DC component of the phase shift information. Note that the gap is located between the center of the horizontal axis (reception position) and the transmitter in FIGS. 5 and 6.

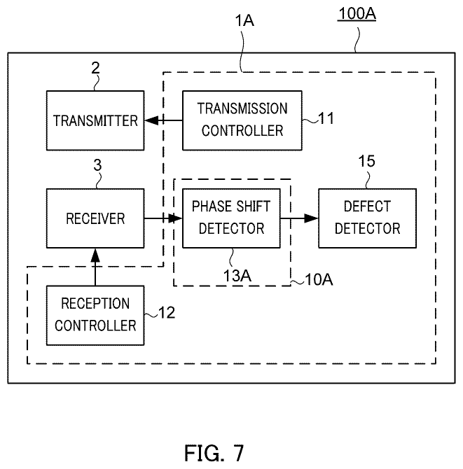

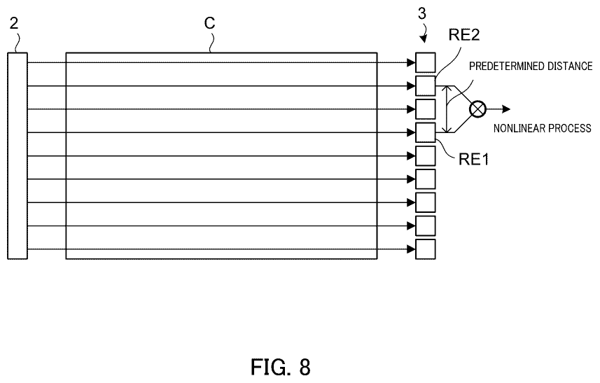

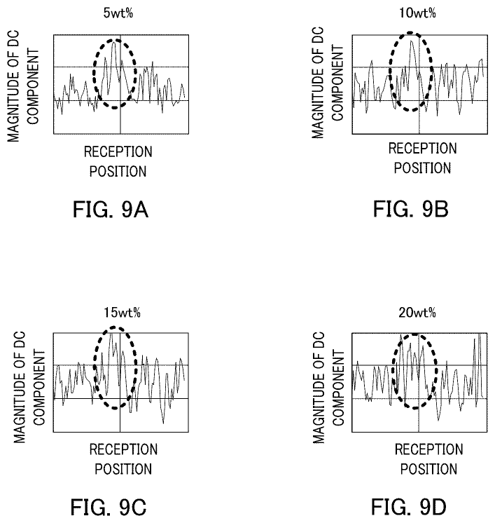

FIG. 5A to FIG. 5D and FIG. 6A to FIG. 6D are graphs in which the content of carbon fibers is used as a parameter, and FIG. 5A and FIG. 6A are graphs in the case where the content of carbon fibers is 5 wt %, FIG. 5B and FIG. 6B are graphs in the case of 10 wt %, FIG. 6 and FIG. 7 are graphs in the case of 15 wt %, and FIG. 8 and FIG. 9 are graphs in the case of 20 wt %, respectively. 6C 5D 6D 5C

When comparing FIGS. 5A and 6A, FIGS. 5B and 6B, FIGS. 5C and 6C, and FIGS. 5D and 6D, respectively, the phase shift information indicates a peak (a place surrounded by a dotted line) in the vicinity of the center of the horizontal axis in the case of the object having a void therein (FIG. 5), whereas no conspicuous peak exists in the case of the object having no void therein (FIG. 6). As described above, it is found that, in a case where there is a defect such as a void inside the object, the phase shift information at the reception position corresponding to the defect position shows a peculiar behavior with respect to the other reception positions.

Note that the variation (random up/down fluctuation) in the phase shift information mainly observed in FIG. 6 is considered to be due to the influence of scattering or the like by the carbon fibers contained in the CFRTP. Here, when FIGS. 5 and 6 are compared, the peak of the phase shift information generated due to a defect or the like is larger than the variation due to internal scattering or the like.

As described above, according to the nondestructive inspecting device 100 of the first embodiment, even when the object includes fibers or the like and is not homogeneous, it is possible to simply and efficiently detect defects or the like in the object.

### Second Embodiment

The first embodiment described above uses, as the reference signal, a signal obtained by simulating the reception signal for each reception element (first reception position) of the receiver 3 in the arithmetic space using the calculation model of the object and the waves equivalent to the waves transmitted by the transmitter 2. In contrast, in the second embodiment, a reception signal at a second reception position different from a first reception position is used as a reference signal used to generate phase shift information at the first reception position.

FIG. 7 is a diagram illustrating an example of the configuration of a nondestructive inspecting device 100A according to the second embodiment. As illustrated in FIG. 7, the nondestructive inspecting device 100A includes a controller 1A, a transmitter 2, and a receiver 3. The controller 1A includes the information generator 10A, the transmission controller 11, the reception controller 12, and the defect detector 15, and the information generator 10A includes only a phase shift detector 13A. Here, in FIG. 7, components performing the same operations as those in the first embodiment are denoted by the same reference numerals as those in the first embodiment, and description thereof will be omitted.

The nondestructive inspecting device 100A according to the second embodiment illustrated in FIG. 7 is different from the nondestructive inspecting device 100 according to the first embodiment in that the reference signal generator 14 is not included. Then, in the nondestructive inspecting device 100A according to the second embodiment, the phase shift detector 13A performs the phase shift detection processing using another signal instead of the reference signal generated by the reference signal generator 14 as the reference signal.

FIG. 8 is a diagram for explaining a phase shift detection process in the nondestructive inspecting device 100A according to the second embodiment. FIG. 8 conceptually illustrates the phase shift detection process for the reception signal generated by the first reception element RE1 among the plurality of reception elements.

In the second embodiment, a phase shift detection process is performed on a reception signal generated by a first reception element REI by using, as a reference signal, a reception signal generated by another reception element disposed at a reception position away from the first reception element RE1 by a predetermined length. FIG. 8 illustrates an example in which a reception signal generated by another reception element (a second reception element RE1) disposed at a reception position adjacent to the first reception element RE2 by two is used as a reference signal. The second embodiment is different from the first embodiment only in which signal is used as the reference signal, and the processing content itself of the phase shift detection processing performed by the phase shift detector 13A is the same as that of the phase shift detector 13 of the first embodiment.

In the second embodiment, a phase shift detection process is performed on the reception signals generated by all the reception elements by using, as a reference signal, a reception signal generated by another reception element separated by a predetermined distance.

In such a phase shift detection process, even when the reception signal generated by the first reception element includes a diffracted wave component diffracted by a defect or the like inside the object, it is expected that the reception signal generated by the second reception element separated by a predetermined distance includes only a straight wave component. In such a case, the phase shift information of the received signal can be extracted by performing the same phase shift detection process as in the first embodiment.

Note that the mechanism of the phase shift detection in the present invention is based on so-called correlated processing, and while the phase shift detector 13 in the first embodiment operates based on the principle of cross-correlation, the phase shift detector 13A in the second embodiment operates based on the principle of auto-correlation. Therefore, in the phase shift detector 13A, reception signals outputted by reception elements spaced apart from the reception elements outputting the reception signals by any predetermined distances in any directions may be used as the reference signals, but more preferably, the reference signals are appropriately determined in accordance with the phase shift amounts of the reception signals to be detected and the size of a defect or the like assumed to be included in the object. In addition, the phase shift information can be extracted more stably by using the results of correlation processing using a plurality of received signals output from a plurality of reception elements separated by different distances, or by further performing statistical processing such as averaging on the results.

As described above, according to the nondestructive inspecting device 100A of the second embodiment, it is possible to efficiently perform the nondestructive inspection while suppressing the manufacturing cost for the reference signal generator 14 compared to the nondestructive inspecting device 100 of the first embodiment.

Next, using the nondestructive inspecting device 100A according to the second embodiment, a CFRTP having a void of 500 μm inside was actually prepared as an object, and the result of nondestructive inspection performed will be shown. FIG. 9 illustrates the relationship between the magnitude of the DC components included in the phase shift information output from the phase shift detector 13A and the reception position, with the content of the carbon fibers in each CFRTP as a parameter. FIG. 9A illustrates the case where the content of the carbon fibers is 5 wt %, FIG. 9B illustrates the case of 10 wt %, FIG. 9C illustrates the case of 15 wt %, and FIG. 9D illustrates the case of 20 wt %. Note that similarly to FIGS. 5 and 6, the horizontal axis of FIG. 9 indicates the reception position, the vertical axis indicates the magnitude of the DC component of the phase shift information, and the gap is located between the center of the horizontal axis (reception position) of FIG. 9 and the transmitter.

Referring to FIG. 9, when there is a defect or the like inside, similarly to FIG. 5, the phase shift information indicates a peak according to the position of the defect or the like. That is, when there is a defect inside the object, the phase shift information at the reception position corresponding to the defect position exhibits a unique behavior with respect to other reception positions.

As described above, the nondestructive inspecting device 100A according to the second embodiment can also easily and efficiently detect a defect or the like in an object.

### Third Embodiment

In the third embodiment, similarly to the first embodiment, a reference signal obtained by simulation in an arithmetic space using a calculation model of an object is used. Here, the third embodiment is different from the first embodiment in that a result obtained by performing nonlinear processing on only the reference signal is used and is subtracted from the phase shift information output from the phase shift detector 13, thereby reducing the influence of the variation of the reference signal itself.

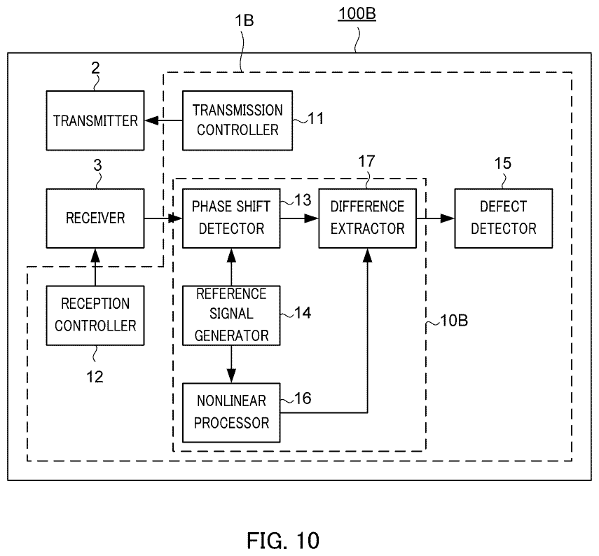

FIG. 10 is a diagram illustrating an example of a configuration of a nondestructive inspecting device 100B according to the third embodiment. In FIG. 10, the nondestructive inspecting device 100B includes a controller 1B, a transmitter 2, and a receiver 3. Further, the controller 1B includes the information generator 10B, the transmission controller 11, the reception controller 12, and the defect detector 15, and the information generator 10B includes the phase shift detector 13, the reference signal generator 14, the nonlinear processor 16, and the difference extractor 17. Here, as illustrated in FIG. 10, the nondestructive inspecting device 100B further includes a nonlinear processor 16 and a difference extractor 17 in addition to the configuration of the nondestructive inspecting device 100.

The nonlinear processor 16 performs nonlinear processing (product operation) only on the reference signal for each reception position. More specifically, the nonlinear processor 16 performs a square operation of the reference signal and outputs the result. The difference extractor 17 extracts, for each reception position, a difference between the phase shift information generated by the phase shift detector 13 and the nonlinear process result generated by the nonlinear processor 16, and outputs the difference to the defect detector 15. The defect detector 15B determines the presence or absence of a defect using the difference.

As described above, according to the nondestructive inspecting device 100B of the third embodiment, it is possible to reduce the influence due to the variation in the reference signal for each reception position and to more stably detect the defect or the like in the object. Note that variations in the reference signals at the respective reception positions can occur due to the influence of scattering of waves by fibers or the like, for example, when an inhomogeneous material is used as the object.

### Fourth Embodiment

The fourth embodiment is different from the first embodiment in that the phase shift detection processing is performed after the amplitude fluctuation (intensity) component is removed from each of the reception signal and the reference signal.

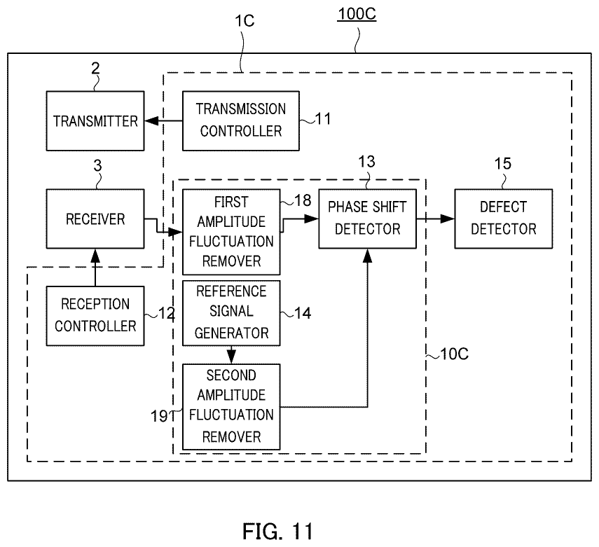

FIG. 1 is a diagram illustrating an example of the configuration of a nondestructive inspecting device 100C according to the fourth embodiment. In FIG. 11, the nondestructive inspecting device 100C includes a controller 1C, a transmitter 2, and a receiver 3. The controller 1C includes the information generator 10C, the transmission controller 11, the reception controller 12, and the defect detector 15, and the information generator 10C includes the phase shift detector 13, the reference signal generator 14, the first amplitude fluctuation remover 18, and the second amplitude fluctuation remover 19. As illustrated in FIG. 11, the nondestructive inspecting device 100C further includes a first amplitude fluctuation remover 18 and a second amplitude fluctuation remover 19 in addition to the configuration of the nondestructive inspecting device 100.

The first amplitude fluctuation remover 18 performs a process of removing the amplitude fluctuation component on the reception signal generated by the receiver 3 for each reception position. The second amplitude fluctuation remover 19 performs a process of eliminating the amplitude fluctuation component on the reference signal for each reception position corresponding to the reception position. As in the first embodiment, the phase shift detector 13 generates phase shift information indicating a change in the phase of the reception signal output from the first amplitude fluctuation remover 18 based on the reference signal output from the second amplitude fluctuation remover 19.

An example of the amplitude fluctuation removal process includes binarization processing using a predetermined threshold. The predetermined threshold value may be set to an appropriate value in advance. As another example, the saturation processing or the clipping processing may be performed when the signal amplitude exceeds a predetermined value.

According to the nondestructive inspecting device 100C of the fourth embodiment, it is possible to reduce the influence due to the fluctuation in the amplitudes of the reception signal and the reference signal and to detect a defect or the like in the object with higher accuracy.

Note that the fourth embodiment has described the case where the first amplitude fluctuation remover 18 to perform the amplitude fluctuation removal process on the reception signal and the second amplitude fluctuation remover 19 to perform the amplitude fluctuation removal process on the reference signal are separately provided, but for example, the same amplitude fluctuation remover may perform the amplitude fluctuation removal process on both of the reception signal and the reference signal.

### Fifth Embodiment

In the first to fourth embodiments, a defect is detected by extracting information about the phase of a received signal. In the fifth embodiment, a defect is detected using not only the phase shift information of the received signal but also the intensity information.

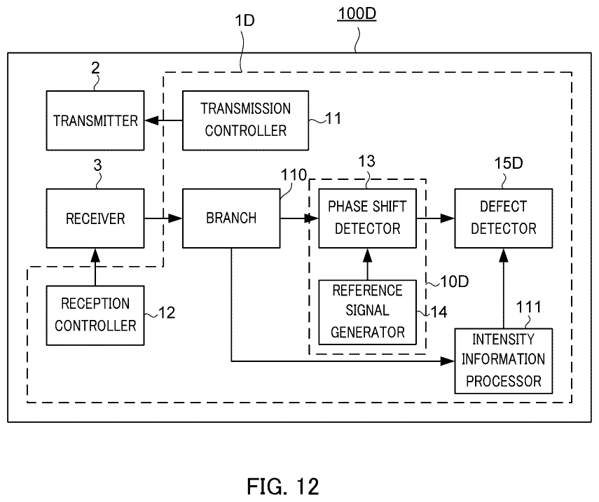

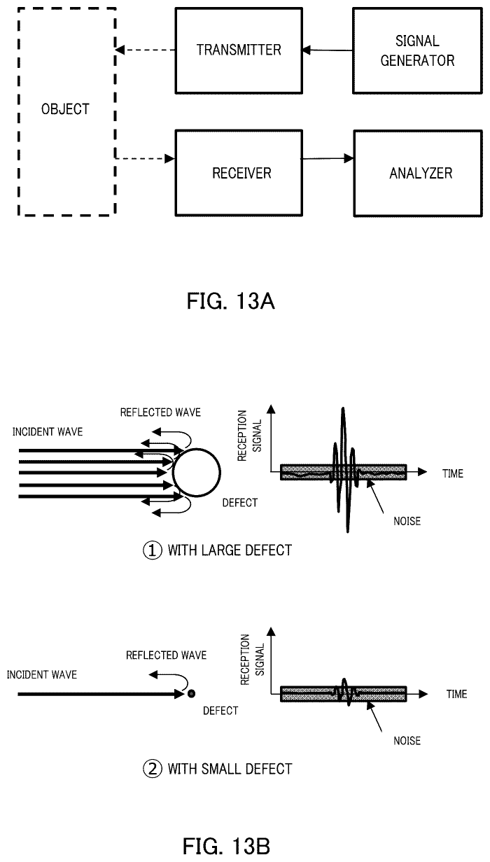

FIG. 12 is a diagram illustrating an example of the configuration of a nondestructive inspecting device 100D according to the fifth embodiment. In FIG. 12, the nondestructive inspecting device 100D includes a controller 1D, a transmitter 2, and a receiver 3. Further, the controller ID includes the information generator 10D, the transmission controller 11, the reception controller 12, the defect detector 15D, the branch 110, and the intensity information processor 111, and the information generator 10D includes the phase shift detector 13 and the reference signal generator 14. Here, as illustrated in FIG. 12, the nondestructive inspecting device 100D further includes a branch 110 and an intensity information processor 111 in addition to the configuration of the nondestructive inspecting device 100. The branch 110 branches the reception signal output from the receiver 3, and the phase shift detector 13 outputs phase shift information of one of the branched reception signals. The intensity information processor 111 performs, on the other of the reception signals branched by the branch 110, predetermined processing based on the intensity information of the reception signal, such as extraction of the intensity information. The defect detector 15D detects a defect based on the phase shift information generated by the phase shift detector and the information outputted from the intensity information processor 111.

Note that the present invention does not particularly limit the predetermined processing that the intensity information processor 111 performs on the intensity information of the reception signal and the predetermined processing that the defect detector 15D performs on the phase shift information and the information outputted from the intensity information processor 111. As appropriate, it is possible to use a known technology related to detection of a defect or the like based on intensity information of a reception signal.

### MODIFICATION EXAMPLE

Each embodiment of the present invention has been described above. However, the present invention is not limited to the configurations illustrated and described in these embodiments, and various modifications can be made.

In the first and third to fifth embodiments, the reference signal generator 14 generates the reference signal, but the present invention is not limited thereto. For example, the nondestructive inspecting device of the present invention may acquire a reference signal generated in advance by an external computer or the like and perform inspection using the reference signal. Further, the nondestructive inspecting device of the present invention may store information on the reference signal generated in advance in a storage or the like, and may read and use the information from the storage at the time of the phase shift detection processing. Further, the method of generating the reference signal is not limited to the above, and for example, when the reference signal is obtained by actual measurement, this may be used or used in combination.

Further, although the reference signal is generated by simulation using the calculation model of the object in the first and third to fifth embodiments, the present disclosure is not limited thereto. Instead of constructing the calculation model of the object in the arithmetic space, another object (reference object) that is made of the same material and has the same structure as the actual object of the nondestructive inspection and that does not include a defect or the like may be prepared, waves may be actually input to the reference object, data of a reception signal may be acquired, and a reference signal may be created on the basis of the data.

In the above-described embodiment, the transmitter 2 transmits a plane wave to the object C, but the present disclosure is not limited thereto. For example, a spherical wave may be adopted. Further, the straight waves may be transmitted from a plurality of transmission positions corresponding to the plurality of reception positions, respectively. In this case, the straight waves do not have to be transmitted from all the transmission positions at the same time, and the straight waves may be sequentially transmitted from a plurality of transmission positions to acquire reception signals at reception positions corresponding to the transmission positions. In this case, the same phase shift detection processing as that in the above-described embodiment can be performed by using the information on the transmission time and the reception time.

The disclosure of the specification, drawings, and abstract included in the Japanese Patent Application No. 2022-120656 Japanese application filed on Jul. 28, 2022 is incorporated herein by reference in its entirety.

### INDUSTRIAL APPLICABILITY

The present invention is useful for a nondestructive inspecting device.

### DESCRIPTION OF SYMBOLS

100, 100a, 100b, 100c, 100d Nondestructive inspecting device
1, 1a, 1b, 1c, 1d Controller
10, 10a, 10b, 10c, 10d Information generator
11 Transmission controller
12 Reception controller
13, 13a Phase shift detector
14 Reference signal generator
15, 15b, 15d Defect detector
16 Nonlinear processor
17 Difference extractor
18 First amplitude fluctuation remover
19 Second amplitude fluctuation remover
110 Branch
111 Intensity information processor
2 Transmitter
3 Receiver

1. A nondestructive inspecting device comprising:
a transmitter that transmits waves to an object;
a receiver that receives, at a plurality of reception positions on a line or a plane substantially orthogonal to a transmission direction of the waves, the waves propagated via the object and generates a reception signal; and
an information generator that performs a predetermined nonlinear process on the reception signal and a predetermined reference signal, and generates phase shift information indicating a phase shift between the reception signal and the reference signal at each of the reception positions.

2. The nondestructive inspecting device according to claim 1, further comprising a defect detector that detects a defect inside the object based on the phase shift information.

3. The nondestructive inspecting device according to claim 1, wherein the reference signal is generated based on a simulation value of a reception signal that is obtained at each of the reception positions when waves equivalent to the waves transmitted by the transmitter are transmitted to a calculation model of the object.

4. The nondestructive inspecting device according to claim 3, wherein the reference signal is generated using the calculation model an internal structure and composition parameters of which substantially match those of the object and which does not include a defect.

5. The nondestructive inspecting device according to claim 1, wherein by using the reception signal at a second reception position different from a first reception position as the reference signal, the information generator generates the phase shift information at the first reception position based the reference signal and on the reception signal at the first reception position.

6. The nondestructive inspecting device according to claim 1, wherein the reference signal is generated based on a reception signal that is obtained at each of the reception positions when waves equivalent to the waves transmitted by the transmitter are transmitted to a reference object that has an internal structure and a composition parameter equivalent to those of the object and is known in advance not to include a defect.

7. The nondestructive inspecting device according to claim 2, further comprising:
a nonlinear processor that performs the nonlinear process on the reference signal; and
a difference extractor that extracts difference information between first nonlinear information obtained by performing the nonlinear process on the reception signal and the reference signal and second nonlinear information output from the nonlinear processor, wherein
the defect detector detects the defect based on the difference information.

8. The nondestructive inspecting device according to claim 1, further comprising:
an amplitude fluctuation remover that performs an amplitude fluctuation removal process for removing an amplitude fluctuation component on the reception signal and the reference signal; and
the phase shift detector calculates the phase shift information based on the reference signal and the reception signal on which the amplitude fluctuation removal process has been performed.

9. The nondestructive inspecting device according to claim 2, wherein the defect detector detects the defect based on the phase shift information output from the phase shift detector and information on an intensity component of the reception signal.

10. A nondestructive inspecting method executed by a computer, the method comprising:
transmitting waves to an object;
receiving, at a plurality of reception positions on a line or a plane substantially orthogonal to a transmission direction of the waves, the waves propagated via the object and generates a reception signal; and
performing a predetermined nonlinear process on the reception signal and a predetermined reference signal, and generates phase shift information indicating a phase shift between the reception signal and the reference signal at each of the reception positions.

11. A non-transitory recording medium storing a computer readable program included in a nondestructive inspecting device, the program causing a computer to execute:
transmitting waves to an object;
receiving, at a plurality of reception positions on a line or a plane substantially orthogonal to a transmission direction of the waves, the waves propagated via the object and generates a reception signal; and
performing a predetermined nonlinear process on the reception signal and a predetermined reference signal, and generates phase shift information indicating a phase shift between the reception signal and the reference signal at each of the reception positions.
